(19) United States
(12) Patent Application Publication
(10) Pub. No.: US 2012/0130011 A1
(43) Pub. Date: May 24, 2012

(54) Methods of Making Chemically Crosslinked Block Copolymer Gels

(75) Inventors: Mark W. Ellsworth, Dublin, CA (US); Michael A. Oar, San Francisco, CA (US)

(73) Assignee: Tyco Electronics Corporation, Berwyn, PA (US)

(21) Appl. No.: 12/954,587

(22) Filed: Nov. 24, 2010

(51) Int. Cl. C08L 53/00

(52) U.S. Cl. 524/585; 525/88; 524/570; 525/95; 525/98

(57) ABSTRACT

Methods are provided of making chemically crosslinked block copolymer gels and chemically crosslinked block copolymer gels. The methods include swelling an olefinic block copolymer having a functionalized soft block region and a functionalized hard block region, in a softener oil, and chemically crosslinking the olefinic block copolymer. Compositions are provided comprising a chemically crosslinked olefinic block copolymer having a functionalized hard block region and a functionalized soft block region and a softener oil.

### BACKGROUND

This application relates to polymeric gels, in particular to a method of making a chemically crosslinked block copolymer gel.

In today's modern electrical and electronic devices, as well as in other uses such as fiber optic connections, sealants are often used for insulation, for protection against water, corrosion and environmental degradation, optical index matching, and thermal management. Prior to now, a number of sealants including gels have been known, however, currently available gel sealants have certain drawbacks and disadvantages that make them inadequate for particular uses.

As technology progresses, sealants will be subjected to increasingly higher temperature environments and more demanding performance requirements. There has been, and there presently exists, a need for high performance sealants to meet these demands.

Gels, for example, have been used as sealants with relative success in certain applications due to their unique properties. Gels may have a lower hardness than rubber and can seal and conform under adequate compression. Gels may also be more elastic than mastics. Other advantages of gels are known in the art. For example, gels, when used as sealants, may be removed and re-entered more easily due to elastic recovery of the gel. For further example, relatively little force is required to change the shape of a soft gel sealant.

One class of gels used as a sealant is thermoplastic elastomer gels (TPEGs). Certain TPEGs have advantages over other classes of gels such as silicone gels, polyurethane gels, and polybutadiene gels. For example, silicone gels may have a higher cost compared to TPEGs, a silicone gel's dielectric breakdown voltage may be adversely affected by humidity, and low surface energy silicone oils can leak or evaporate out of the gel and spread over electrical contact points leading to problematic insulation barriers. Problems with polyurethane and polybutadiene gels include, for example, hydrolytic instability of the crosslinked network; and degradation and hardening with aging. In addition, environmental concerns regarding certain non-TPEG gels has led to an increased interest in developing gels with enhanced safety profiles while achieving sufficient or enhanced properties.

TPEGs have provided many years of reliable in-field performance for applications requiring a low maximum service temperature of approximately 70° C. TPEGs have been made that comprise a styrene ethylene/butylene styrene (“SEBS”) triblock copolymer swollen with a mineral oil softener. While the thermoplastic nature of these gels allows for easy production, it limits the upper service temperature due to creep and flow as in-field ambient temperatures approach the styrene glass transition. Research has been aimed at increasing the upper service temperature of these gels through chemically crosslinking the gel network in order to form a thermoset gel structure. For example, oil-swelled acid/anhydride modified maleic anhydride SEBS gels have been covalently crosslinked using small molecule crosslinkers like di- and triamines, EP 0879832A1, as well as with some metal salts, D. J. St. Clair, “Temp Service,” Adhesives Age, pp. 31-40, September 2001. Crosslinked polymers are known to increase thermal stability, toughness, and chemical resistance compared to their base, or uncrosslinked polymers. However, crosslinked polymers are also known to often be intractable, making them difficult to reprocess or recycle.

For further example, a type of TPEG, styrenic block copolymers (“SBCs”), SBCs may provide environmental stability, attainable softness, and other desirable physical properties. A block copolymer is made of two or more different polymers covalently bonded end-to-end. A wide variety of block copolymer conformations are possible, although most thermoplastic elastomer block copolymers involve the covalent bonding of hard blocks, which are substantially crystalline or glassy, to soft elastomeric blocks. Other block copolymers, such as rubber-rubber (elastomer-elastomer), glass-glass, and glass-crystalline block copolymers, are also possible and may have commercial importance.

SBCs can be compounded with high percentages (e.g., 70-95%) of hydrocarbon oil to produce soft thermoplastic gel materials that are suitable for low temperature electrical sealing applications (≦70° C.). While SBCs are suitable for certain applications, SBCs have other disadvantages that make them inadequate in particular applications. For example, SBCs may exude an unacceptable amount of oil, may have a viscosity that prohibits or complicates processing, and may not have a sufficiently high service temperature.

Methods of modifying the block copolymers of TPEGs have been disclosed. For example, methods of preparing maleated block copolymers are known in the art and such block copolymers are commercially available.

U.S. Pat. No. 7,608,668 discloses ethylene/α-olefin block interpolymers. These polymers may be synthesized via chain shuttling technology. Moreover, hybrid olefin block copolymers with hard and soft blocks have been enhanced by the incorporation of oil.

U.S. Pat. No. 6,207,752 to Abraham et al. relates to low oil swell carboxylated nitrile rubber-thermoplastic polyurethane vulcanizate compositions. The nitrile rubbers of Abraham contain pendant carboxyl groups that can be crosslinked. The patentees report unexpectedly discovering that a processing aid can improve the processability of the compositions. The patent lists a number of processing aids including maleated polyethylene, maleated styrene-ethylene-butene-styrene-block copolymers and maleated styrene-butadiene-styrene-block copolymers, and maleated ethylene-propylene rubber.

### BRIEF SUMMARY

In one aspect, methods are provided of making chemically crosslinked block copolymer gels. The provided methods include a method of making a chemically crosslinked block copolymer gel comprising the steps of swelling an olefinic block copolymer having a functionalized soft block region and a functionalized hard block region in a softener oil, and chemically crosslinking the olefinic block copolymer.

In another aspect, compositions are provided comprising chemically crosslinked block copolymer gels. The compositions include a chemically crosslinked olefinic block copolymer having a hard block region and a soft block region, wherein the hard block region and the soft block region comprise a functional group grafted to the hard block region and the soft block region, and a softener oil.

In a further aspect, methods are provided of using compositions comprising chemically crosslinked block copolymer gels.

### BRIEF DESCRIPTION OF THE FIGURES

FIG. 1 is a flow chart of a method of making a chemically crosslinked block copolymer gels.

FIG. 2a is a styrenic triblock copolymer with two hard block regions and a soft block region.

FIG. 2b is a styrenic triblock copolymer with two hard block regions and a soft block region with only soft block region functionalized with maleic anhydride groups.

FIG. 3 is an olefinic multiblock copolymer with alternating soft block regions and hard block regions, where both soft block regions and hard block regions are functionalized with maleic anhydride groups.

FIG. 4 is a graph showing the percent deflection (y-axis) for three samples at various temperatures in ° C. (x-axis).

### DETAILED DESCRIPTION

As used herein, terms such as “typically” are not intended to limit the scope of the claimed invention or to imply that certain features are critical, essential, or even important to the structure or function of the claimed invention. Rather, these terms are merely intended to highlight alternative or additional features that may or may not be utilized in a particular embodiment of the present invention.

As used herein the terms “comprise(s),” “include(s),” “having,” “has,” “contain(s),” and variants thereof, are intended to be open-ended transitional phrases, terms, or words that do not preclude the possibility of additional acts or structure.

As used herein, “polymer” means a polymeric compound prepared by polymerizing monomers, whether of the same or a different type. The generic term “polymer” embraces the terms “homopolymer,” “copolymer,” “terpolymer” as well as “interpolymer.”

As used herein, “interpolymer” means a polymer prepared by the polymerization of at least two different types of monomers. The generic term “interpolymer” includes the term “copolymer” (which is usually employed to refer to a polymer prepared from two different monomers) as well as the term “terpolymer” (which is usually employed to refer to a polymer prepared from three different types of monomers). It also encompasses polymers made by polymerizing four or more types of monomers.

As used herein, the term a “hard” with respect to regions of a polymer refers to a block of polymerized units in which ethylene is present in an amount greater than 95 weight percent.

As used herein, the term “soft” segments, on the other hand, with respect to regions of a polymer refer to blocks of polymerized units where the non-ethylene content is greater than 5 weight percent.

As used herein, the term “crystalline” refers to a polymer or a segment that possesses a first order transition or crystalline melting point (Tm) as determined by differential scanning calorimetry (DSC) or equivalent technique.

As used herein, the term “amorphous” refers to a polymer lacking a crystalline melting point as determined by differential scanning calorimetry (DSC) or equivalent technique, or refers to a polymer that is amorphous at the temperature range of interest and has a melting point or glass transition below the temperature of interest.

Any concentration range, percentage range, or ratio range recited herein are to be understood to include concentrations, percentages or ratios of any integer within that range and fractions thereof, such as one tenth and one hundredth of an integer, unless otherwise indicated. Also, any number range recited herein relating to any physical feature are to be understood to include any integer within the recited range, unless otherwise indicated. It should be understood that the terms “a” and “an” as used above and elsewhere herein refer to “one or more” of the enumerated components. For example, “a” polymer refers to one polymer or a mixture comprising two or more polymers.

### Methods of Making Chemically Crosslinked Block Copolymer Gels

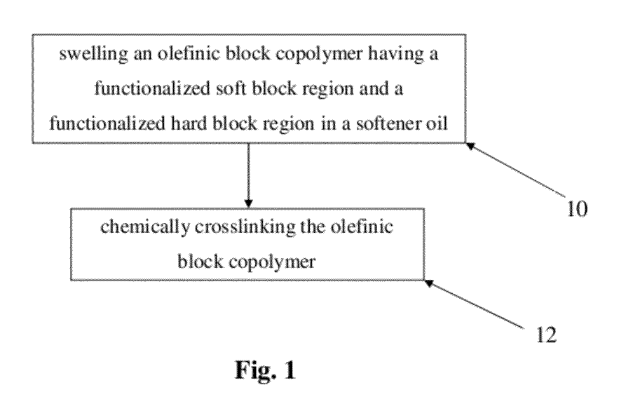

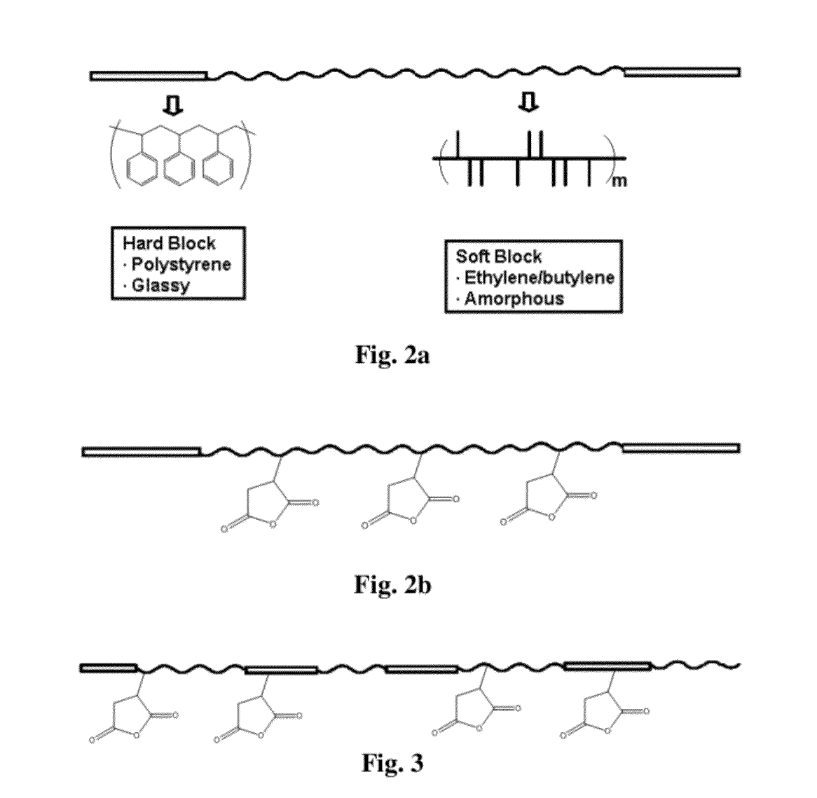

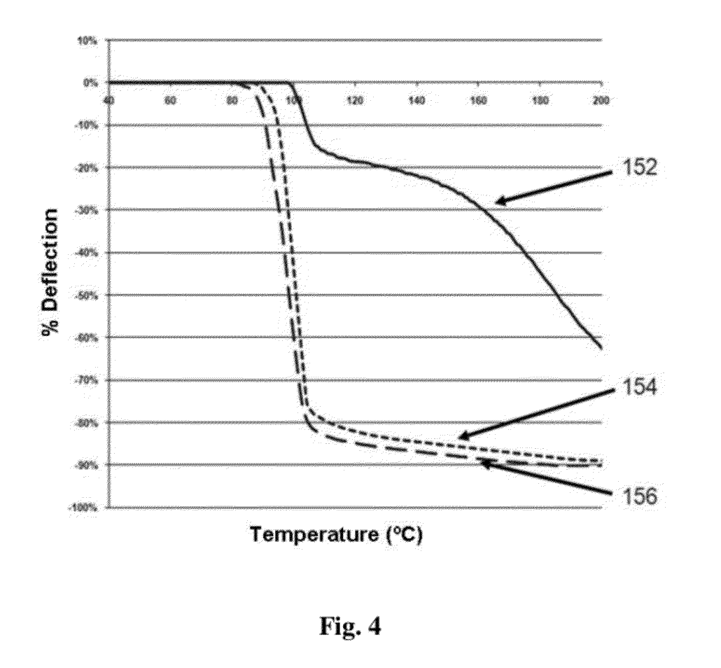

In general, as shown in FIG. 1, the methods described herein include swelling an olefinic block copolymer having a functionalized soft block region and a functionalized hard block region in a softener oil in a softener oil 10 and chemically crosslinking the olefinic block copolymer 12. The olefinic block copolymer includes at least one soft block region and at least one hard block region. The soft block region and hard block region are functionalized so that they are configured to chemically crosslink. For example, the soft and hard block regions are functionalized with an acid group or an anhydride group. The presence of functionalized soft and hard blocks, and the subsequent chemical crosslinking provides polymers with a number of surprising and unexpected properties. For example, FIG. 4 shows three the percent deflection (y-axis) for three samples at various temperatures in ° C. (x-axis). A composition comprising a chemically crosslinked maleic anhydride grafted olefinic block copolymer 152 showed reduced deflection at temperatures around 100° C. to around 200° C. compared to the same non-chemically crosslinked maleic anhydride grafted olefinic block copolymer 154 and the non-maleic anhydride grafted olefinic block copolymer 156. Additional details, aspects and embodiments are provided herein.

### Olefinic Block Copolymer

The olefinic block copolymer has at least one hard block region and at least one soft block region. In one embodiment, the olefinic block copolymer has alternating hard block regions and soft block regions. In another embodiment, the density of the olefinic block copolymer is between 0.850 g/cm³ and 0.890 g/cm³. In a further embodiment, the density of the olefinic block copolymer is between 0.860 g/cm³ and 0.880 g/cm³. In another embodiment, the density of the olefinic block copolymer is between 0.860 g/cm³ and 0.870 g/cm³.

The hard block region includes a block of polymerized units which is greater than 95 weight percent ethylene and may include another comonomer. In some embodiments, the hard block region is greater than 97 weight percent ethylene. In other words, the comonomer content in the hard block region is less than 5 percent in some embodiments, and less than 2 percent in other embodiments. In other embodiments, the hard block region is greater than 98 weight percent ethylene, and greater than 99 weight percent ethylene in other embodiments.

The hard block region is relatively rigid and in some embodiments is crystalline. In other embodiments, the hard block region is glassy. In other embodiments, the hard block is semicrystalline. In other embodiments, the hard block region comprises high density polyethylene. In yet other embodiments, the hard block region comprises linear low density polyethylene.

In some embodiments, the hard segments comprise all or substantially all ethylene. In one embodiment, ethylene comprises the majority mole fraction of the whole hard block region, i.e., ethylene comprises at least about 50 mole percent of the whole hard block region. In other embodiments ethylene comprises at least about 60 mole percent, at least about 70 mole percent, or at least about 80 mole percent, with the substantial remainder of the whole hard block region comprising at least one other comonomer that an α-olefin having 3 or more carbon atoms. In some ethylene/octene embodiments, the ethylene content is greater than about 80 mole percent of the hard block region and an octene content of from about 10 to about 15. In other ethylene/octene embodiments, the octene content is from about 15 to about 20 mole percent of the hard block region.

In one embodiment, the hard block region includes polystyrene. In another embodiment, the hard block region comprises crystallizable ethylene-octene blocks with very low comonomer.

In contrast to the hard block region, the soft block region includes a block of polymerized units in which the comonomer content is greater than 5 weight percent. In various embodiments, the soft block region is greater than 8 weight percent comonomer, greater than 10 weight percent, or greater than 15 weight percent. In further embodiments, the comonomer content in the soft segments can be greater than 20 weight percent, greater than 25 eight percent, greater than 30 weight percent, greater than 35 weight percent, greater than 40 weight percent, greater than 45 weight percent, greater than 50 weight percent, or greater than 60 weight percent. The soft block region is relatively elastomeric and in some embodiments is amorphous.

In another embodiment, the soft block includes ethylene and butylene. In a further embodiment, the soft block includes low density polyethylene. In yet a further embodiment, the soft block comprises ultra low density polyethylene.

The olefinic block copolymer may have a number of conformations and geometries. For example, the olefinic block copolymer may be a graft polymer. The olefinic block copolymer may also be a diblock polymer, triblock polymer, or other multiblock polymer. The olefinic block copolymer may have random polymer regions, but must have at least one hard block region and at least one soft block region.

In some embodiments, the olefinic block copolymer is an ethylene α-olefin interpolymer. The term “ethylene α-olefin interpolymer” generally refers to polymers comprising ethylene and an α-olefin having 3 or more carbon atoms. In other embodiments, the olefinic block copolymer comprises other ethylene/olefin polymers. Any suitable olefin may be used in embodiments of the olefinic block copolymer. “Olefin(s)” and “olefinic” as used herein refer to a family of unsaturated hydrocarbon-based compounds with at least one carbon-carbon double bond.

In some embodiments, the olefinic block copolymer includes ethylene and a suitable comonomer. Suitable unsaturated comonomers useful for polymerizing with ethylene include, for example, ethylenically unsaturated monomers, conjugated or nonconjugated dienes, polyenes, alkenylbenzenes, etc. Examples of such comonomers include C₃-C₂₀ α-olefins such as propylene, isobutylene, 1-butene, 1-hexene, 1-pentene, 4-methyl-1-pentene, 1-heptene, 1-octene, 1-nonene, 1-decene, and the like. Other suitable comonomers include styrene, halo- or alkyl-substituted styrenes, vinylbenzocyclobutane, 1,4-hexadiene, 1,7-octadiene, and naphthenics (e.g., cyclopentene, cyclohexene and cyclooctene).

In some embodiments, the olefinic block copolymer includes other suitable olefins such as C₃-C₂₀ aliphatic and aromatic compounds containing vinylic unsaturation, as well as cyclic compounds, such as cyclobutene, cyclopentene, dicyclopentadiene, and norbornene, including but not limited to, norbornene substituted in the 5 and 6 position with C₁-C₂₀ hydrocarbyl or cyclohydrocarbyl groups. Also included are mixtures of such olefins as well as mixtures of such olefins with C₄-C₄₀ diolefin compounds.

Examples of olefinic comonomers include, but are not limited to propylene, isobutylene, 1-butene, 1-pentene, 1-hexene, 1-heptene, 1-octene, 1-nonene, 1-decene, and 1-dodecene, 1-tetradecene, 1-hexadecene, 1-octadecene, 1-eicosene, 3-methyl-1-butene, 3-methyl-1-pentene, 4-methyl-1-pentene, 4,6-dimethyl-1-heptene, 4-vinylcyclohexene, vinylcyclohexane, norbornadiene, ethylidene norbornene, cyclopentene, cyclohexene, dicyclopentadiene, cyclooctene, C₄-C₄₀ dienes, including but not limited to 1,3-butadiene, 1,3-pentadiene, 1,4-hexadiene, 1,5-hexadiene, 1,7-octadiene, 1,9-decadiene, other C.sub.4-C₄₀ α-olefins, and the like. In certain embodiments, the α-olefin is propylene, 1-butene, 1-pentene, 1-hexene, 1-octene or a combination thereof. Although any hydrocarbon containing a vinyl group potentially may be used in embodiments, practical issues such as comonomer availability, cost, and the ability to conveniently remove unreacted monomer from the resulting polymer may become more problematic as the molecular weight of the monomer becomes too high.

In some embodiments, the olefinic block copolymer includes monovinylidene aromatic comonomers including styrene, o-methyl styrene, p-methyl styrene, t-butylstyrene, and the like. In other embodiments, the olefinic block copolymer includes non-conjugated diene monomers. Suitable non-conjugated diene monomers can be a straight chain, branched chain or cyclic hydrocarbon diene having from 6 to 15 carbon atoms. Examples of suitable non-conjugated dienes include, but are not limited to, straight chain acyclic dienes, such as 1,4-hexadiene, 1,6-octadiene, 1,7-octadiene, 1,9-decadiene, branched chain acyclic dienes, such as 5-methyl-1,4-hexadiene; 3,7-dimethyl-1,6-octadiene; 3,7-dimethyl-1,7-octadiene and mixed isomers of dihydromyricene and dihydroocinene, single ring alicyclic dienes, such as 1,3-cyclopentadiene; 1,4-cyclohexadiene; 1,5-cyclooctadiene and 1,5-cyclododecadiene, and multi-ring alicyclic fused and bridged ring dienes, such as tetrahydroindene, methyl tetrahydroindene, dicyclopentadiene, bicyclo-(2,2,1)-hepta-2,5-diene; alkenyl, alkylidene, cycloalkenyl and cycloalkylidene norbornenes, such as 5-methylene-2-norbornene (MNB); 5-propenyl-2-norbornene, 5-isopropylidene-2-norbornene, 5-(4-cyclopentenyl)-2-norbornene, 5-cyclohexylidene-2-norbornene, 5-vinyl-2-norbornene, and norbornadiene.

In one embodiment, the olefinic block copolymer comprises ethylene, a C₃-C₂₀ α-olefin, especially propylene, and optionally one or more diene monomers. In other embodiments, α-olefins for use in this embodiment are designated by the formula CH₂═CHR*, where R* is a linear or branched alkyl group of from 1 to 12 carbon atoms. Examples of suitable α-olefins include, but are not limited to, propylene, isobutylene, 1-butene, 1-pentene, 1-hexene, 4-methyl-1-pentene, and 1-octene. In another embodiment, the α-olefin is propylene. The propylene based polymers are generally referred to in the art as EP or EPDM polymers. Suitable dienes for use in preparing such polymers, especially multi-block EPDM type polymers include conjugated or non-conjugated, straight or branched chain-, cyclic- or polycyclic-dienes comprising from 4 to 20 carbons. In some embodiments, the diene is selected from the group consisting of 1,4-pentadiene, 1,4-hexadiene, 5-ethylidene-2-norbornene, dicyclopentadiene, cyclohexadiene, and 5-butylidene-2-norbornene and combinations thereof. In another embodiment, the diene is 5-ethylidene-2-norbornene.

In one embodiment, the olefinic block copolymer is a polymer disclosed as an embodiment, or “inventive polymer” or “inventive interpolymer” in U.S. Pat. No. 7,608,668, which is hereby incorporated by reference in its entirety.

In one embodiment, the olefinic block copolymer is selected from the group consisting of ethylene olefin block copolymer, propylene olefin block copolymer, ethylene-pentene olefin block copolymer, ethylene-heptene olefin block copolymer, ethylene-hexene block copolymer, ethylene-octene olefin block copolymer, ethylene-nonene olefin block copolymer, ethylene-decene olefin block copolymer, propylene-ethylene olefin block copolymer, ethylene α-olefin random copolymer, ethylene α-olefin block copolymer, or mixtures thereof.

Examples of olefinic block copolymers are elastomeric copolymers of polyethylene, sold under the trade name INFUSE by The Dow Chemical Company of Midland, Mich. (e.g., INFUSE 9107). In one embodiment, the olefinic block copolymer is selected from the group consisting of INFUSE OBC 9000, INFUSE OBC 9007, INFUSE OBC 9100, INFUSE OBC 9107, INFUSE OBC 9500, INFUSE OBC 9507, INFUSE OBC 9530, INFUSE OBC 9807, INFUSE OBC 9817, and mixtures thereof.

As discussed herein, the olefinic block copolymer includes a functionalized hard block region and a functionalized soft block region. The olefinic block copolymer may have been functionalized with a number of functional groups, with the restriction that the functional groups must have been configured to chemically crosslink when exposed to a crosslinker. For example, the olefinic block copolymer may be maleated. See FIG. 4. In some embodiments, the hard block region and soft block region are functionalized with a maleate group. Methods of preparing maleated block copolymers are known in the art and such block copolymers are commercially available. For example, maleated block copolymers are disclosed in EP 0879832A1. In some embodiments, the hard block region and soft block region is functionalized with an acid group. In other embodiments, the hard block region and soft block region are functionalized with an anhydride group.

### Softener Oils

The olefinic block copolymer is swelled in a softener oil. In one embodiment, the softener oil is a mineral oil. In yet another embodiment, the softener oil is a paraffin oil. In other embodiments, the softener oil is a napthenic oil. In yet other embodiments, the softener oil is an aromatic oil. In a further embodiment, the softener oil is a mixture of different types of oils.

In one embodiment, the softener oil is a polyalpha olefin. Polyalpha olefins are hydrogenated synthetic hydrocarbon fluids used in a large number of automotive, electrical, and other industrial applications. DURASYN polyalpha olefins are authorized for use as components of non-food articles and are considered non-toxic. For example, DURASYN 148 polyalphaolefin is a fully synthesized hydrogenated hydrocarbon base fluid produced from C₁₂ linear alphaolefin feed stocks and available from INEOS Oligomers, Houston, Tex.

Other suitable softener oils are known in the art, and others are disclosed in EP 0879832A1. In another embodiment, the softener oil is a linear alpha olefin. In yet another embodiment, the softener oil is a white mineral oil. An illustrative commercially available mineral oil is HYDROBRITE 380 PO (Sonneborn).

### Crosslinkers

The methods include chemically crosslinking the olefinic block copolymer with a crosslinker. Any crosslinker capable of reacting with the functionalized hard and soft block regions can be utilized. In one embodiment, the chemical crosslinking involves ionic crosslinking. In other embodiments, the chemical crosslinking involves covalent crosslinking.

In one embodiment, the crosslinker is a metal salt. In another embodiment, the crosslinker is aluminum acetylacetonate. In further embodiments, the crosslinker is selected from the group consisting of aluminum acetylacetonate, zinc acetylacetonate, titanium acetylacetonate and zirconium acetylacetonate, and mixtures thereof. In another embodiment, the crosslinker is an aluminum salt of acetic acid. For example, the crosslinker may be an aluminum triacetate (Al(C₂H₃O₂)₃), aluminum diacetate, (HO(Al(C₂H₃O₂)₃), or aluminum monoacetate, ((HO)₂(Al(C₂H₃O₂)₃). In another embodiment, the crosslinker is tetra(2-ethylhexyl)titanate.

In other embodiments, the crosslinker is an amine crosslinker. In further embodiments, the amine crosslinker is selected from the group consisting of an organic amine, an organic diamine, and an organic polyamine. In other embodiments, the amine crosslinker is selected from the group consisting of ethylene diamine; 1,2- and 1,3-propylene diamine; 1,4-diaminobutane; 2,2-dimethylpropane diamine-(1,3); 1,6-diaminohexane; 2,5-dimethylhexane diamine-(2,5); 2,2,4-trimethylhexane diamine-(1,6); 1,8-diaminooctane; 1,10-diaminodecane; 1,11-undecane diamine; 1,12-dodecane diamine; 1-methyl-4-(aminoisopropyl)-cyclohexylamine-1; 3-aminomethyl-3,5,5-trimethyl-cyclohexylamine-(1); 1,2-bis-(aminomethyl)-cyclobutane; p-xylylene diamine; 1,2- and 1,4-diaminocyclohexane; 1,2-; 1,4-; 1,5- and 1,8-diaminodecalin; 1-methyl-4-aminoisopropyl-cyclohexylamine-1; 4,4′-diamino-dicyclohexyl; 4,4′-diamino-dicyclohexyl methane; 2,2′-(bis-4-amino-cyclohexyl)-propane; 3,3′-dimethyl-4,4′-diamino-dicyclohexyl methane; 1,2-bis-(4-aminocyclohexyl)-ethane; 3,3′,5,5′-tetramethyl-bis-(4-aminocyclohexyl)-methane and -propane; 1,4-bis-(2-aminoethyl)-benzene; benzidine; 4,4′-thiodianiline, dianisidine; 2,4-toluenediamine, diaminoditolylsulfone; 2,6-diaminopyridine; 4-methoxy-6-methyl-m-phenylenediamine; diaminodiphenyl ether; 4,4′-bis(o-toluidine); o-phenylenediamine; o-phenylenediamine, methylenebis(o-chloroaniline); bis(3,4-diaminiophenyl)sulfone; diaminiodiphenylsulfone; 4-chloro-o-phenylenediamine; m-aminobenzylamine; m-phenylenediamine; 4,4′-C₁-C₆-dianiline such as 4,4′-methylenedianiline; aniline-formaldehyde resin; and trimethylene glycol di-p-aminobenzoate and mixtures thereof.

In further embodiments, the amine crosslinker is selected from the group consisting of bis-(2-aminoethyl)-amine, bis-(3-aminopropyl)-amine, bis-(4-aminobutyl)-amine and bis-(6-aminohexyl)-amine, and isomeric mixtures of dipropylene triamine and dibutylene triamine. In yet further embodiments, the amine crosslinker is selected from the group consisting of hexamethylene diamine, tetramethylene diamine, and dodecane diamine and mixtures thereof.

In other embodiments, the crosslinker is a polyol crosslinker. In further embodiments, the polyol crosslinker is selected from the group consisting of polyether-polyols, polyester-polyols, branched derivatives of polyether-polyols (derived from, e.g., glycerine, sorbitol, xylitol, mannitol, glucosides, 1,3,5-trihydroxybenzene), branched derivatives of polyether-polyols (derived from, e.g., glycerine, sorbitol, xylitol, mannitol, glucosides, 1,3,5-trihydroxybenzene), orthophthalate-based polyols, ethylene glycol-based polyols, diethylene glycol-based aromatic and aliphatic polyester-polyols. In further embodiments, the polyol crosslinker is selected from the group consisting of 1,2-propanediol, 1,3-propanediol, diethanolamine, triethanolamine, N,N,N′,N′-[tetrakis(2-hydroxyethyl)ethylene diamine], N,N,-diethanolaniline. In other embodiments, the polyol crosslinker is selected from the group consisting of polycaprolactone diol, poly(propylene glycol), poly(ethylene glycol), poly(tetramethylene glycol), polybutadiene diol and their derivatives or copolymers.

### Optional Ingredients

### Stabilizers

In some embodiments, the compositions disclosed and made by methods disclosed herein contain at least one stabilizer. Stabilizers include antioxidants, light and UV absorbers/stabilizers, heat stabilizers, metal deactivators, free radical scavengers, carbon black, and antifungal agents.

### Other Optional Components

The compositions and methods are not limited to the types of components listed here. Other common components may also be included in the compositions used according to the methods disclosed. For example, the compositions may include coloring agents, fillers, dispersants, flow improvers, plasticizers, and/or slip agents.

### End Uses

The chemically crosslinked gels described herein may be used in a number of end uses due to the improved properties. For examples, in some embodiments, the chemically crosslinked gels are used in fiber optic closure boxes. In other embodiments, the chemically crosslinked gels are used as electrical sealants. In further embodiments, the chemically crosslinked gels are used as electrical closures. In other embodiments, the chemically crosslinked gels are used as gel wraps, clamshells, or gel caps.

In some embodiments, the chemically crosslinked gels are used in environments in excess of 70° C. In other embodiments, the chemically crosslinked gels are used in environments in excess of 100° C. In further embodiments, the chemically crosslinked gels are used in environments in excess of 140° C. In other embodiments, the chemically crosslinked gels are used in environments in excess of 160° C. In other embodiments, the chemically crosslinked gels are used in environments in excess of 200° C.

### Example

An olefinic block copolymer having alternating soft block and hard block regions (product sold under the trade name, INFUSE 9007, available from Dow Chemical Co., Midland, Mich.) was melted at 115° C. under low shear in a BRABENDER (Duisburg, Germany) mixer for two minutes. Maleic anhydride was added, allowed to melt, and then mixed for one minute. An amount of olefinic block copolymer equal to the starting material was added along with dicumyl peroxide to the mixture. The resulting mixture was mixed for twelve minutes. The product was allowed to cool and this maleic anhydride functionalized resin was used to make gels. The resin was swollen with mineral oil in a double planetary mixer. The mixture was then chemically crosslinked with aluminum acetylacetonate. The resulting crosslinked compositions resisted tearing and had an improved compression set properties at 70° C. compared to non-crosslinked and non-functionalized olefinic block copolymers.

Although examples have been described herein, it should be appreciated that any subsequent arrangement designed to achieve the same or similar purpose may be substituted for the specific examples shown. This disclosure is intended to cover any and all subsequent adaptations or variations of various examples. Combinations of the above examples, and other examples not specifically described herein, may be apparent to those of skill in the art upon reviewing the description.

The Abstract is provided with the understanding that it will not be used to interpret or limit the scope or meaning of the claims. In addition, in the foregoing Detailed Description, various features may be grouped together or described in a single example for the purpose of streamlining the disclosure. This disclosure is not to be interpreted as reflecting an intention that the claimed examples require more features than are expressly recited in each claim. Rather, as the following claims reflect, inventive subject matter may be directed to less than all of the features of any of the disclosed examples. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other examples, which fall within the true spirit and scope of the description. Thus, to the maximum extent allowed by law, the scope is to be determined by the broadest permissible interpretation of the following claims and their equivalents, and shall not be restricted or limited by the foregoing detailed description.

What is claimed is:

1. A method of making a chemically crosslinked block copolymer gel comprising:
swelling an olefinic block copolymer in a softener oil, said olefinic block copolymer having
a functionalized soft block region and
a functionalized hard block region; and
chemically crosslinking the olefinic block copolymer.

2. The method of claim 1, wherein the olefinic block copolymer comprises ethylene and an α-olefin monomer.

3. The method of claim 2, wherein the α-olefin monomer is selected from the group consisting of styrene, propylene, 1-butene, 1-hexene, 1-octene, 4-methyl-1-pentene, norbornene, 1-decene, 1,5-hexadiene, or a combination thereof.

4. The method of claim 2, wherein the α-olefin monomer is 1-octene.

5. The method of claim 1, wherein the olefinic block copolymer comprises alternating soft block regions and hard block regions.

6. The method of claim 1, wherein the hard block region comprises high density polyethylene.

7. The method of claim 1, wherein the soft block region comprises low density polyethylene.

8. The method of claim 1, wherein the hard block region comprises at least 95% by weight ethylene.

9. The method of claim 1, wherein the hard block region comprises at least 98% by weight ethylene.

10. The method of claim 1, wherein the soft block region comprises less than 50% by weight ethylene.

11. The method of claim 1, wherein the hard block region comprises less than 30% by weight ethylene.

12. The method of claim 1, wherein the hard block region and soft block region are functionalized with an acid group.

13. The method of claim 1, wherein the hard block region and soft block region are functionalized with an anhydride group.

14. The method of claim 1, wherein the hard block region is functionalized with an acid group.

15. The method of claim 1, wherein the olefinic block copolymer is crosslinked with a metal salt.

16. The method of claim 1, wherein the olefinic block copolymer is crosslinked with a crosslinker selected from the group consisting of aluminum acetylacetonate, zinc acetylacetonate, titanium acetylacetonate and zirconium acetylacetonate.

17. The method of claim 1, wherein the olefinic block copolymer is crosslinked with aluminum acetylacetonate.

18. A composition comprising:
a chemically crosslinked olefinic block copolymer having a hard block region and a soft block region, wherein the hard block region and the soft block region comprise a functional group grafted to the hard block region and the soft block region, and
a softener oil.

19. The composition of claim 17, wherein the chemically crosslinked olefinic block copolymer comprises alternating soft block regions and hard block regions.

20. The composition of claim 17, wherein the hard block region comprises high density polyethylene and the soft block region comprises low density polyethylene.

21. The composition of claim 17, wherein the crosslinker is aluminum acetylacetonate.

22. A method of using a composition of claim 18 in an end use selected from the group consisting of a fiber optic closure boxes, electrical sealants, electrical closures, gel wraps, clamshells, and gel caps.
